(19) United States
(12) Patent Application Publication
(10) Pub. No.: US 2005/0012813 A1
(43) Pub. Date: Jan. 20, 2005

(54) Display apparatus with an image freeze function and image freeze method therefor

(76) Inventor: Tsung-Hsun Wu, Taoyuan City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/880,778

(22) Filed: Jun. 30, 2004

(30) Foreign Application Priority Data
Jul. 4, 2003 (TW) 092118430

(51) Int. Cl. H04N 7/14; A62B 1/04

(52) U.S. Cl. 348/14.14

(57) ABSTRACT

A display apparatus with an image freeze function for displaying image data supplied from a signal source includes a detector, a microprocessor control unit and a freeze circuit. The detector is coupled to the signal source to judge whether or not the image data is output. When the image data is lost, the detector feeds a detection signal to the microprocessor control unit to notify the fact that the image data does not exist. The microprocessor control unit receives the detection signal and then utilizes control signals to enable the freeze circuit to continuously output a previous page of image data and avoid screen blanking. The detector may judge whether or not the image data exists according to image control signals of the image data, which may be horizontal sync signals or vertical sync signals.

This application claims the benefit of Taiwan application Serial No. 92118430, filed Jul. 4, 2003, the subject matter of which is incorporated herein by reference.

### BACKGROUND OF THE INVENTION

1. Field of the Invention

The invention relates to a display apparatus and an image processing method therefor, and more particular to a display apparatus with an image freeze function and an image freeze method therefor.

2. Description of the Related Art

With the highly developed technology in the industry, the quality of the presentation apparatus in the meeting room is greatly improved, wherein the projector plays an important role in the meeting because its signal quality directly influences the visual feelings of all the attendant members.

The functionality (or operation convenience) of the projector highly relates to the smoothness of the presentation. Operating some specific functions may effectively enhance the smoothness of the presentation and make the attendant members feel more comfortable. For example, the image freeze function of the projector may be enabled to freeze the old image on the screen without blanking before the image is switched, and then be disabled after the new image is ready to be displayed on the screen so that the screen blanking between the interval of image switching may be avoided.

In general, a computer output signal is often adopted as the signal source for the projector in the meeting. The presenter utilizes a computer system, such as a PC or a notebook computer to sequentially output the image data one by one to the projector. When the presentation page is to be changed, the image freeze function of the projector is enabled manually by, for example, touching some functional key so that the current image data may be frozen on the screen. After a next image data is output to the projector (the old image is stilled displayed on the screen), the image freeze function is disabled manually and a next page of image is displayed on the screen.

Furthermore, the presentation data has to be amended occasionally in the meeting. In this case, the user may first enable the image freeze function to freeze the previous image on the screen, and then cut off the signal source of the projector in order to facilitate the amendment of the computer data (the old image is still displayed on the screen). After the amendment is completed, the signal source is again connected to the projector and the image freeze function is disabled so that the amended data may be displayed. Such a method may avoid the screen blanking caused when the data is amended, and the attendant members may concentrate on the information displayed on the screen and continue discussing to make the meeting atmosphere smoother during the blanking interval of the data amendment.

Although the above-mentioned method can avoid the blanking during the page-switching or waiting time, the presenter has to press the key of the projector twice to enable or disable the image freeze function at each time, and it is quite inconvenient.

### SUMMARY OF THE INVENTION

It is therefore an object of the invention to provide a display apparatus with an image freeze function and an image freeze method therefor. The display apparatus may automatically enable the image freeze function when the signal source is lost or the page is switched, and disable the image freeze function after the signal source is reconnected or the page is switched so that the updated image is displayed to avoid the blanking image.

The invention achieves the above-identified object by providing a display apparatus with an image freeze function. The display apparatus for displaying image data supplied from a signal source includes a detector, a microprocessor control unit and a freeze circuit. The detector is coupled to the signal source to judge whether or not the image data exists. When the image data is lost, the detector feeds a detection signal to the microprocessor control unit to notify the fact that the image data does not exist. The microprocessor control unit receives the detection signal, and then utilizes control signals to enable the freeze circuit to continuously output a previous page of image data, thereby avoiding the screen blanking. The detector may judge whether or not the image data exists according to the image control signals of the image data, which are horizontal sync signals, vertical sync signals, or the like.

Furthermore, the display apparatus may be used in conjunction with a transfer apparatus, which feeds a new image to the display apparatus only when the image is updated so as to reduce the power consumption and save the bandwidth. The transfer apparatus includes a buffer device and a comparator device. The buffer device buffers the image data to be a reference image data, and then outputs the reference image data to the comparator device. The comparator device compares the image data with the content of the reference image data. If the image data and the reference image data are the same, the comparator device has no output. Otherwise, the comparator device outputs the image data. The transfer apparatus may also include a transmitter for receiving the image data fed from the comparator device and outputting the image data to the display apparatus for display. The transmitter may be an infrared emitter, a radio frequency signal emitter, or the like.

The invention also achieves the above-identified object by providing an image freeze method including the following steps.

First, the system may judge whether or not the image exists according to the image control signals of the image data. If yes, the image data is refreshed and stored as backup image data. Next, the system displays the stored backup image data for a period of time and goes back to the judging procedure as mentioned above. If the system judges that the image data does not exist, it continuously displays the backup image data. After a period of time, if the image data exists again, the system refreshes the image data and stores the image data again. Then, the stored backup image data is displayed to replace the old image. Thus, no blanking image is displayed during the image switching procedure.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram showing a display apparatus with an image freeze function according to a first embodiment of the invention.

FIG. 2 is a flow chart showing an image freeze method.

FIG. 3 is a block diagram showing an image transmission apparatus according to a second embodiment of the invention.

### DETAILED DESCRIPTION OF THE INVENTION

FIG. 1 is a block diagram showing a display apparatus 150, such as a projector, with an image freeze function according to a first embodiment of the invention. The display apparatus 150 for processing image data IMG fed from a signal source 110 includes a detector 151, a microprocessor control unit (MCU) 153 and a freeze circuit 155. The signal source 110 may be an output signal from a computer, and the image data IMG may be a static image such as presentation data and the like. After the image data IMG is fed to the detector 151, the detector 151 may judge whether or not the image data IMG exists according to some image control signals, such as horizontal sync signals (Hsync), vertical sync signals (Vsync), or the like, in the image data IMG. When the image data IMG exists, it may be fed to the MCU 153, which may further process the image data IMG by way of, for example, resolution, contrast or brightness adjusting, through the detector 151. Then, the MCU 153 outputs image data IMG′ to the freeze circuit 155, which stores and then outputs the image data IMG′. At this time, the display signal DIS output from the freeze circuit 155 corresponds to the image data IMG fed from the signal source 110 and may be displayed on the screen.

During the blanking interval of page-changing (a previous page has been removed and a next page is not presented) or when the signal source 110 is cut off, the detector 151 may immediately judge that the image data IMG is lost according to the above-mentioned image control signals, and feed a detection signal DT to the MCU 153 to notify the fact that the image data IMG does not exist. After the MCU 153 receives the detection signal DT, the control signal CS may be fed to the freeze circuit 155 in order to enable the freeze circuit 155 to continuously output a previous page of image data without screen blanking. In brief, when the image data IMG is lost, the image data IMG′ also does not exist because the image data IMG′ is obtained from the MCU 153 that processes the image data IMG. However, when the image data IMG is not lost, the freeze circuit 155 has already made a copy of the content of the image data IMG′. So, the freeze circuit 155 may continuously output the backup image data when the image data IMG is lost, thereby freezing the previous page of image on the screen without being lost.

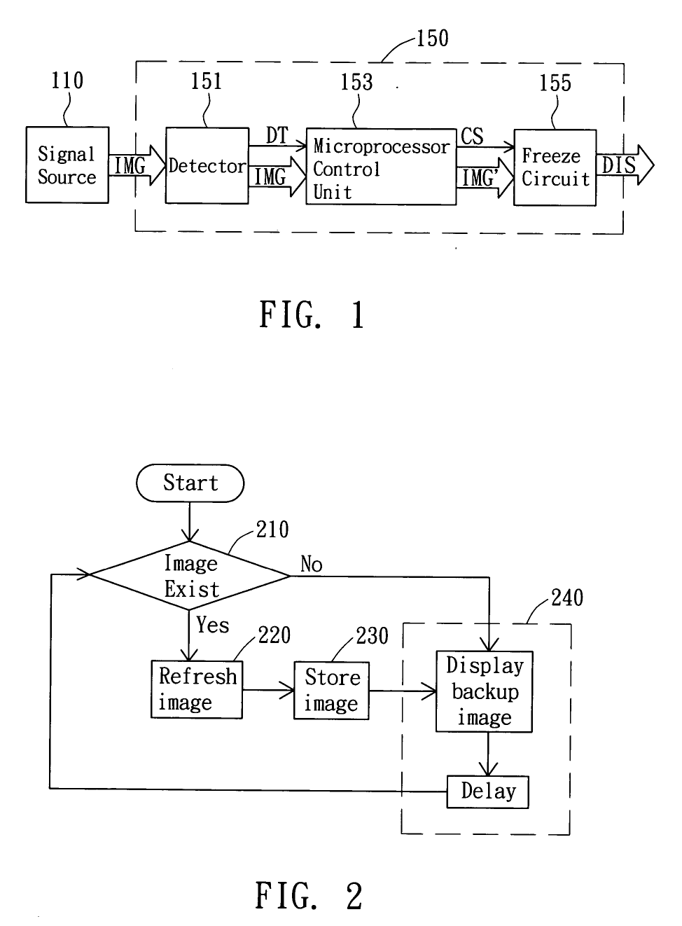

FIG. 2 is a flow chart showing an image freeze method, which may be applied to the display apparatus 150 of FIG. 1. First, the system may judge whether or not the image exists according to the image control signals of the image data (step 210). If the image data exists, the image data is refreshed (step 220) and then stored in a memory (step 230) as backup image data, wherein the memory may be disposed in the freeze circuit 155. Next, in step 240, the system displays the backup image data, which has been stored, for a period of time and the process then goes back to the judgement procedure of step 210. The delay time of the backup image data may be set according to the actual requirement. For example, the delay time may be 10 ms, wherein the system checks whether or not the image exists every ten microseconds.

On the other hand, if it is judged that the image data does not exist (during the page-changing interval or when the signal source is lost) when step 210 is performed, the system continuously displays the backup image data (i.e., an old image before the signal source is lost) stored in the memory, for a period of time. Thereafter, if the image data exists again after the period of time (i.e., a new image is ready or the signal source is reconnected), the system refreshes the image data (i.e., replaces the old image with the new image), stores the new image again, and displays the stored backup image data to replace the old image. So, no blank image is displayed on the screen during the image switching process.

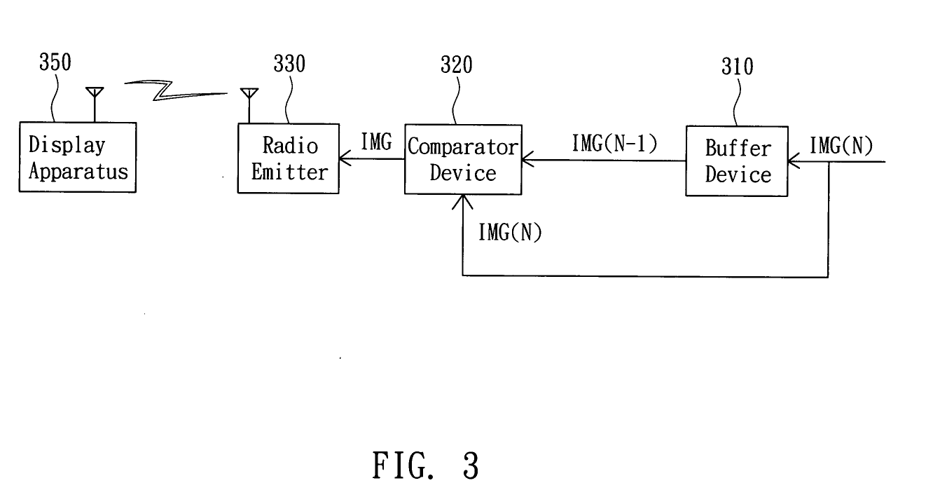

Since the image freeze method of the invention may keep displaying the old image after the image data is lost, if the image data of the signal source is not updated, it is only necessary to make the display apparatus freeze the old image without continuously feeding the data to the display apparatus. In other words, the signal source only has to feed the new image data to the display apparatus during the image switching process. After the display apparatus makes a copy of the new image and then displays the new image, the new image data from the signal source may be removed. When the image is updated next time, another new image data is again fed to the display apparatus. Consequently, the bandwidth may be saved and the power loss of the signal source may be reduced. FIG. 3 is a block diagram showing an image transmission apparatus according to a second embodiment of the invention. As shown in FIG. 3, the image transmission apparatus is used to transfer the image data IMG to a display apparatus 350, which may have the image freeze function the same as the first embodiment. The image transmission apparatus is mainly composed of a buffer device 310 and a comparator device 320 for implementing the idea of transferring the image data IMG to the display apparatus 350 only when the image is updated. In the aspect of signal transfer, the image data IMG may be directly fed to the display apparatus 350 via a signal line, such as a cable, an optical fiber, or the like (not shown). Alternatively, the image data IMG may be fed from a transmitter 330 such as an infrared emitter or radio frequency (RF) signal emitter to the display apparatus 350 by way of radio transmission.

The buffer device 310 functions to buffer the image data and simultaneously feed the image data from the buffer device and the image data corresponding to the current image into the comparator device 320 for comparison. If both of them are the same, the comparator device 320 outputs nothing. Otherwise, the comparator device 320 outputs the image data corresponding to the current image. For example, the buffer device 310 may buffer the image data for one second, and when the buffer device 310 receives the image data IMG(N) at the N-th second, it also synchronously outputs the image data IMG(N−1) at the (N−1)th second. The comparator device 320 compares the image data IMG(N) with the image data IMG(N−1). If both of them are the same, it means that the image has not been updated. So, no image data has to be output, and the display apparatus 350 continues to display the backup image data stored in the memory. On the contrary, if the image data IMG(N) is different from the image data IMG(N−1), it means that the image has been updated. At this time, the comparator device 320 outputs the newer image data IMG(N), which is the image data IMG received by the display apparatus 350 to refresh the old image. The method for updating the image has been described above, and detailed description thereof will be omitted. Since whether or not the image data IMG(N) is updated has to be determined with reference to the content of the image data IMG(N−1), the image data IMG(N−1) may be regarded as reference image data. Also, the buffered image data may be regarded as the reference image data, and whether or not the image data corresponding to the current image has been updated may be determined according to the buffered image data. Of course, the delay time for the buffer device 310 is not limited to one second, but may be additionally set according to the actual requirement.

The display apparatus with an image freeze function and the image freeze method according to the above-mentioned embodiments of the invention at least have the following advantages.

The image freeze function may be automatically enabled to enhance the operation convenience.

The display apparatus may be used in conjunction with the image transmission apparatus to reduce the power loss and save the bandwidth.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A display apparatus for displaying an image data supplied from a signal source, the display apparatus comprising:
a detector, coupled to the signal source, for detecting the existence of the image data;
a microprocessor control unit (MCU), coupled to the detector, for receiving and processing the image data for output; and
a freeze circuit for temporarily storing and then outputting the image data coming from the microprocessor control unit, wherein when the detector detects that the image data is absent, the microprocessor control unit enables the freeze circuit to output the image data storing in the freeze circuit for displaying.

2. The display apparatus according to claim 1, wherein the detector detects the existence of the image data exists according to image control signals of the image data.

3. The display apparatus according to claim 2, wherein the image control signals are horizontal sync signals (Hsync).

4. The display apparatus according to claim 2, wherein the image control signals are vertical sync signals (Vsync).

5. The display apparatus according to claim 1, wherein the image data is a static image.

6. The display apparatus according to claim 1, wherein the display apparatus is a projector.

7. The display apparatus according to claim 1, wherein the signal source is an output signal from a computer.

8. An image transmission apparatus for processing an image data, the image transmission apparatus comprising:
a buffer device for buffering the image data to be a reference image data and then outputting the reference image data; and
a comparator device, coupled to the buffer device, for comparing the image data with the reference image data, wherein the comparator device outputs the image data when the image data is different from the reference image data, and the comparator device stops outputting the image data when the image data is the same as the reference image data.

9. The image transmission apparatus according to claim 8, further comprising a transmitter coupled to the comparator device to receive and output an outputting signal from the comparator device.

10. The image transmission apparatus according to claim 9, wherein the transmitter is an infrared emitter.

11. The image transmission apparatus according to claim 9, wherein the transmitter is a radio frequency (RF) signal emitter.

12. The image transmission apparatus according to claim 8, wherein the image data is a static image.

13. An image freeze method for displaying image data, the image freeze method comprising the steps of:
(a) storing the image data as a backup image data;
(b) judging whether or not the image data continuously exists, performing step (c) if not, and performing step (d) if yes;
(c) displaying the backup image data and performing step (b) after a period of delay time; and
(d) refreshing the image data and then executing steps (a) and (c).

14. The image freeze method according to claim 13, wherein the image data is a static image.
